(19) United States
(12) Patent Application Publication
(10) Pub. No.: US 2006/0101518 A1
(43) Pub. Date: May 11, 2006

(54) Method to generate a quantitative measurement of computer security vulnerabilities

(76) Inventors: Troy T. Schumaker, Pine, CO (US); Demetrios Lazarikos, Denver, CO (US)

Correspondence Address: Mark A. Thomas, P.C., 10138 South Cottoncreek Drive, Highlands Ranch, CO, 80130-3848, US

(21) Appl. No.: 11/268,983

(22) Filed: Nov. 7, 2005

Related U.S. Application Data
(60) Provisional application No. 60/625,682, filed on Nov. 5, 2004.
(60) Provisional application No. 60/625,678, filed on Nov. 5, 2004.
(60) Provisional application No. 60/625,679, filed on Nov. 5, 2004.

(51) Int. Cl. G06F 11/00

(52) U.S. Cl. 726/25

(57) ABSTRACT

The present invention provides a system and method to provide a measurement of the risk that a computer network may have to computer security threats. The system includes a collocation facility that is coupled to a plurality of computer security management systems. Some or all of the vulnerability information is reported to the collocation facility. At the collocation facility, this information is compared to a standard. This comparison yields a number or other measurement of that organization's risk in its computer security. The collocation facility can then report this measurement to any information user that wishes to know what the vulnerability is for that organization.

### CROSS REFERENCES TO RELATED APPLICATIONS

This patent application claims the benefit of provisional U.S. Patent Application Ser. No. 60/625,682, filed Nov. 5, 2004, provisional U.S. Patent Application Ser. No. 60/625,678, filed Nov. 5, 2004 and provisional U.S. Patent Application Ser. No. 60/625,679, filed Nov. 5, 2004, all of which are hereby incorporated by reference in their entireties.

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The invention relates generally to computer network security. In particular, the invention relates to the creation of a quantitative measurement of the overall computer security of an organization.

2. Description of the Related Art

Computers are a necessity for almost every organization in operation today. Computers manage and direct operations, store information, and provide the essential tools for completing organizational projects. Over the course of the past decades, organizations have begun connecting these computers together into large networks that interconnect most or all of the organization's computing assets. Once public networks, such as the World Wide Web, developed, organizations started connecting their networks to these global networks. These connections to the global networks offered new business opportunities and access to a wealth of information. However, there was a downside to connecting to the public networks.

The interconnectedness has, along with its advantages, created an environment where computers may be attacked or accessed by unauthorized entities. Interconnected computers are vulnerable to viruses, denial of service attacks, and many other insidious invasions. To address these vulnerabilities, vulnerability scanning and resolution became a requirement for any organization with a computer network attached to a public network. Security consulting firms filled the market with a labor intensive approach to discovering and resolving network security vulnerabilities. More recently, some of the scanning functions have become automated, providing security personnel with the ability to find vulnerabilities in the local network. Tools were developed to help remediate the vulnerabilities.

Unfortunately, security problems still exist. Some of the computer attacks result in substantial monetary losses to the organizations affected by the breaches in computer security. Thus, organizations have started insuring themselves against loss of access, loss of data, or loss of computer availability in light of these ever increasing security threats. As this type of insurance has become more popular, insurance firms and other entities have been trying to determine how to quantify the security risk to each organization's computer network.

Actuarial scientists use measures and statistical data to determine what a company should be charged for certain types of insurance. For instance, a teenage boy has higher insurance rates than a middle-aged woman because the teenage boy presents a higher probability, according to historical data, for accidents than does the middle-aged woman. Actuarial scientists have desired to create a similar quantitative determination for computer security vulnerability. In this way, insurance firms can better target insurance to organizations wishing to protect themselves financially from computer security threats. Unfortunately, no quantitative system has been developed that can measure an organization's risk to computer security problems.

### SUMMARY OF THE INVENTION

The present invention provides a system and method to provide a quantitative measurement of the risk that a computer network may have to computer security threats. The system includes a collocation facility that is coupled to a plurality of computer security management systems. The computer security management systems include a first controller device, referred to as an Enterprise Server, that exercises control over one or more remote testing devices. The remote testing devices accomplish scanning of the distributed networks but remain under the control and management of the Enterprise Server.

To complete a vulnerability measurement of the computer network, the Enterprise Server schedules scans for each of the remote testing devices. The remote testing devices scan the network to which they are attached. Each remote testing device reports the results of the several scans to the Enterprise Server. The Enterprise Server may consolidate the results to create an organization wide vulnerability database.

Information about the computer security vulnerabilities is consolidated at the Enterprise Server. Some or all of this information is reported to the collocation facility. At the collocation facility, this information is compared to a standard. This comparison yields a quantitative measurement or a qualitative measurement of that organization's risk to its computer security. The collocation facility can then report this information to any information user that wishes to know what the vulnerability is for that organization.

### BRIEF DESCRIPTION OF THE DRAWINGS

FIG. 1 shows an embodiment of a system to discover and remediate computer network vulnerabilities in a distributed network system according to the present invention.

FIG. 2 shows an embodiment of an Enterprise Server according to the present invention.

FIG. 3 shows an embodiment of a remote testing device according to the present invention.

FIG. 4 shows an embodiment of a system to distribute and receive vulnerability information among a collocation facility and a plurality of computer security management systems according to the present invention.

FIG. 5 shows an embodiment of a collocation facility according to the present invention.

FIG. 6A and FIG. 6B show an embodiment of a method to generate a measurement of the computer security of an organization according to the present invention.

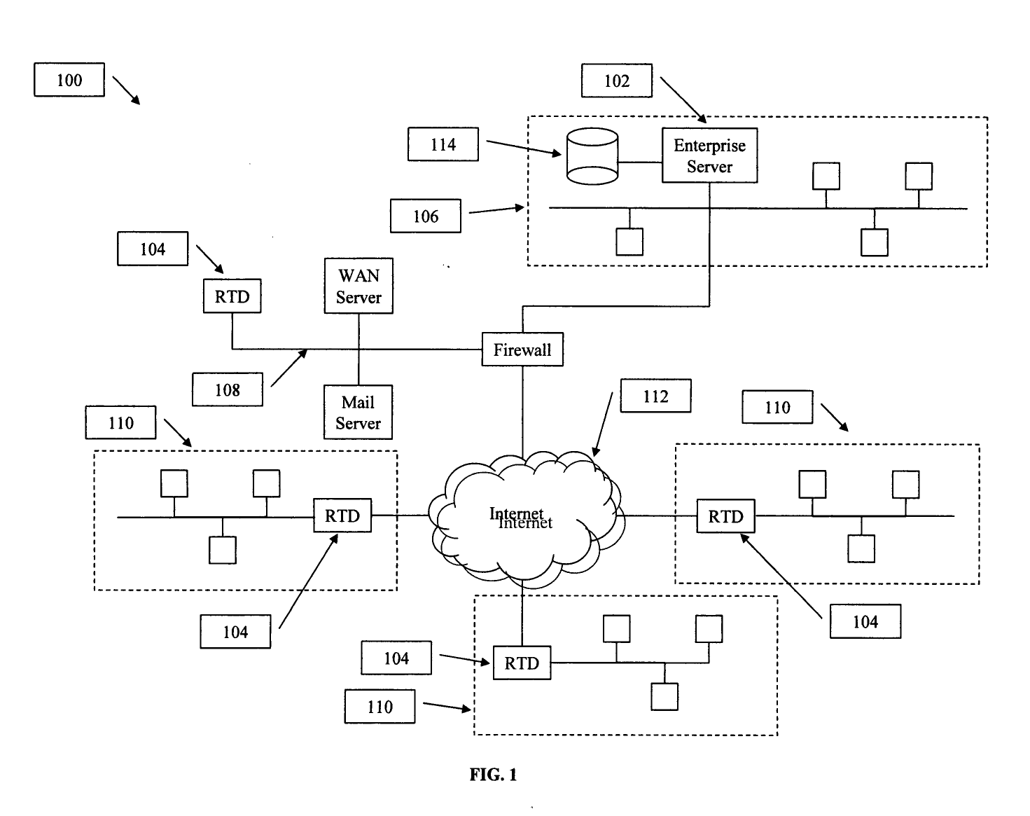

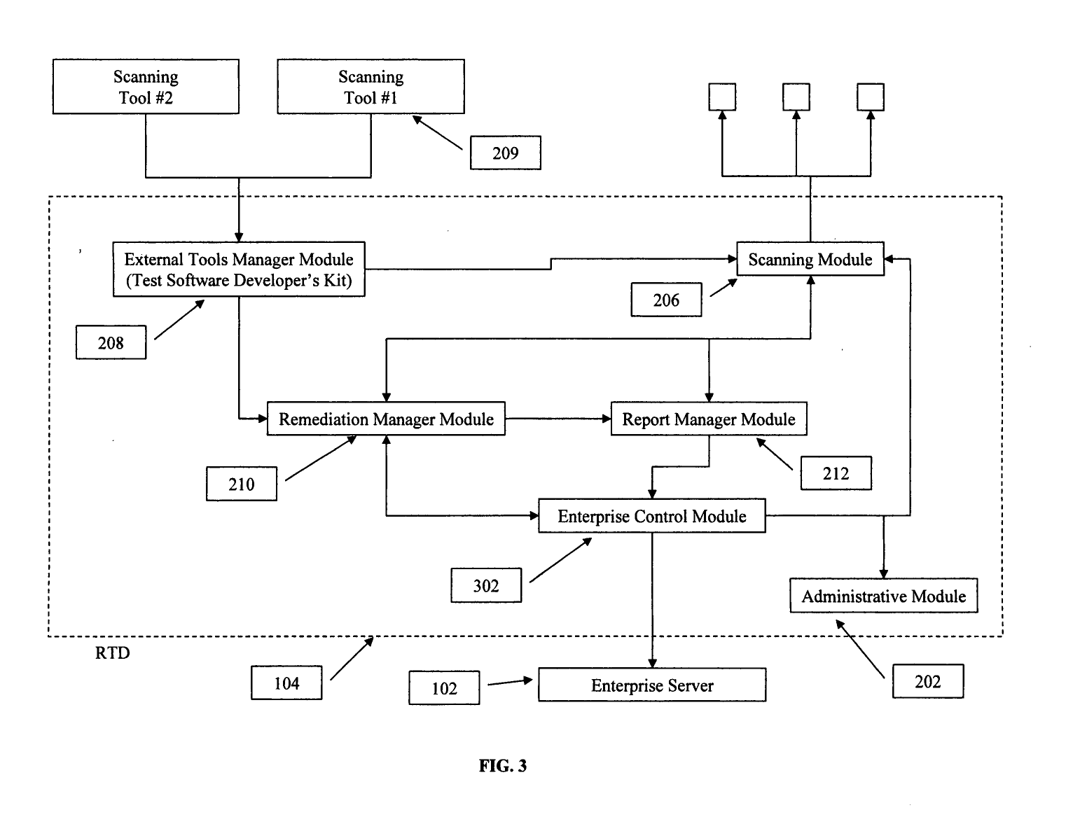

To clarify, each drawing includes reference numerals. These reference numerals follow a common nomenclature. The reference numerals will have three or four digits. The first one or two digits represent the drawing number where the reference numeral was first used. For example, a reference numeral first used in drawing one will have a number like 1XX while a number first used in drawing five will have a number like 5XX. The second two numbers represent a specific item within a drawing. One item in FIG. 1 will be 101 while another item will be 102. Like reference numerals used in other drawings represent the same item. For example, reference numeral 102 in FIG. 3 is the same item as shown in FIG. 1.

### DETAILED DESCRIPTION OF THE INVENTION

This disclosure sets forth specific embodiments and details to provide sufficient understanding of the present invention. However, one skilled in the art will recognize that the invention may be practiced without these specific details or in a form different than the specific embodiments. In addition, some diagrams use block diagrams or general schematics not to overburden the description with unneeded details. It will be noted that the invention may be performed in either hardware, software, or a combination of hardware and software. Certain terms and names are used to refer to particular systems throughout the description and the claims. One skilled in the art will appreciate that particular systems may be referred to by different names or different terms, and this description attempts to distinguish between components by function rather than name. Throughout this description, the term “couple”, “couples”, or “coupled” means any type of direct or indirect electrical or communicative connection. Any connection or information exchange in the present invention may be bi-directional. Distributed Vulnerability Assessment and Management System

The Distributed Vulnerability Assessment and Management System (DVAMS) 100 may be a portal architecture as shown in FIG. 1. An Enterprise Server 102 is coupled to one or more remote testing devices (RTD) 104. The Enterprise Server 102 is a single unit located at a central location 106 or a headquarters location. Each RTD 104 is located on a sub-network 108 or distant network 110 separated by some distance. Each location 110 or sub-network 108 may have one or more RTDs 104. The Enterprise Server 102 may communicate bi-directionally with the RTDs 104 through an internet 112, such as the World Wide Web, or through an intranet, such as a LAN or WAN. Communications are completed in the network protocol of the internet or intranet used, but preferably, in an https protocol. This distributed vulnerability management model 100 provides remote scanning of several networks 108 or 110 and central control of the computer security management system 100. Each of the systems will be explained in more detail below.

Enterprise Server 102

The Enterprise Server 102 can provide the local network with the same functions as the RTD 104. In addition, the Enterprise Server 102 functions as the central control for all of the RTDs 104. As an example, the Enterprise Server 102 can be a 1U rack mounted server operating a Linux operating system, coded in Java with an API program interface that can accept XML inputs, and can have one or more bidirectional couplings to other systems. The server may be running a Pentium X86 processor and have a memory that can include a relational database developed in MySQL. The Enterprise Server 102 may also be a software module installed on a computer connected to the network. In addition, the Enterprise Server 102 may be a self bootable program stored on a computer readable media that can be run from system memory of an existing network device. The Enterprise Server 102 may also be connected to one or more memories 114 to store information in a database. The memories 114 may include, but are not limited to, RAID systems, RAM, ROM, disk drives, optical storage, or tape storage.

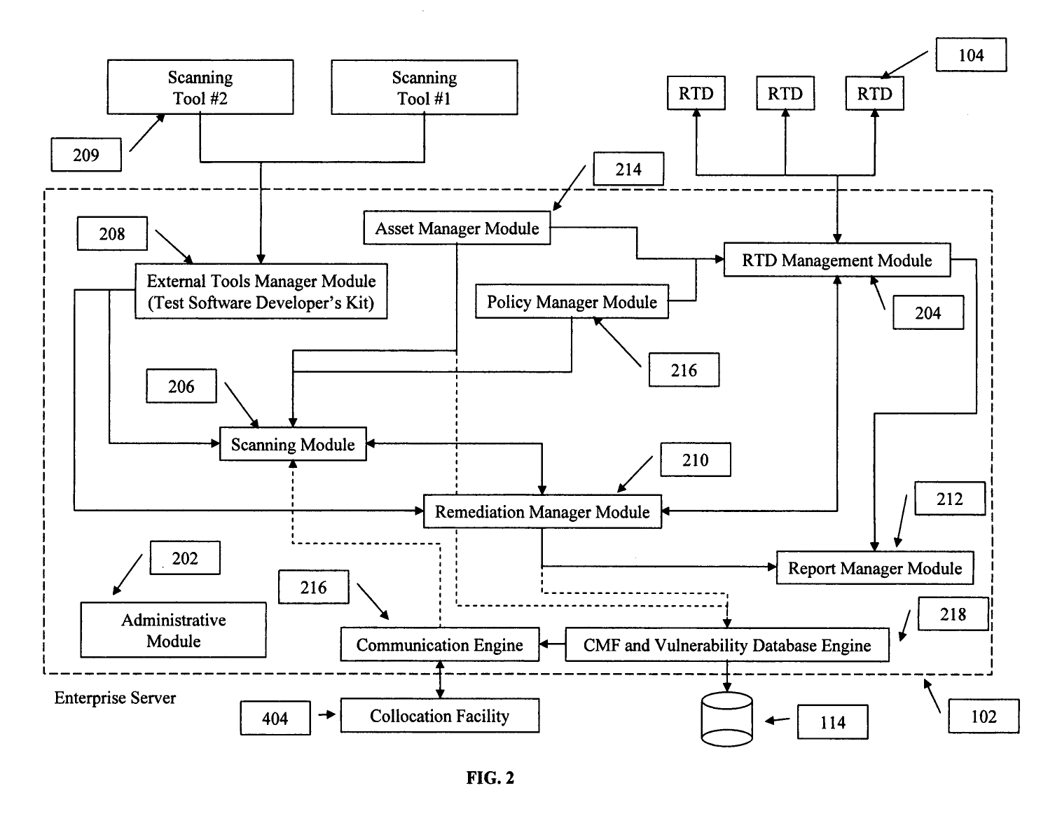

An embodiment of the Enterprise Server 102 is shown in FIG. 2. The Enterprise Server 102 includes a RTD Management Module 204. The Enterprise Server 102 may also include an asset manager module 214, a policy manager module 216, a scanning module 206, a remediation module 210, a report manager module 212 an administrative module 202, an external tools manager module (also referred to as the software developer's kit or SDK) 208, a communication engine 216 coupled to a collocation facility 404, and a CMF and vulnerability database engine 218 that stores information in the database 114. Each of the modules has certain functions. One or more of the modules may be coupled or connected, sharing information either uni-directionally or bi-directionally. These modules may be integrated into a single computer or distributed among several computers. Each module with exemplary functions and exemplary interconnections will be described further hereinafter.

The administrative module 202 controls access to the Enterprise Server 102. This module 202 assigns access privileges to different individuals. An identification code and a password may be given to each privileged user to allow them access to the Enterprise Server 102. Privileges may differ from person to person. Some people may have general access to the Enterprise Server 102, while other users may have more limited access.

The RTD Management Module 204 controls and interacts with the RTDs 104. The Enterprise Server 102 can determine for the RTDs 104 what tests and scans may be run, when the tests and scans may be run, on what system devices to run the tests and scans, and how to report and manage the vulnerabilities identifies by the tests and scans. More specifically, the RTD management module 204 will connect with the each RTD 104 to establish a time to run a certain scan (or to run that scan immediately). For instance, one RTD 104 may be connected to a network in Europe. The RTD management module 204 can schedule that RTD 104 to run a scan during the evening in Europe. A second RTD 104 may be in California, and the Enterprise Server 102 can schedule that RTD 104 to run the same scan during the evening in California. Thus, the RTDs 104 may run the same scans at different times in different places and be managed by the same RTD management module 204. In addition, the remote scanning ability of the computer security management system 100 alleviates the need for a large bandwidth connection between the Enterprise Server 102 and the remote networks to allow the Enterprise Server 102 to remotely scan those remote networks.

Once a scan is run by an RTD 104, the RTD 104 may report several items of information to the RTD management module 204 including, but not limited to, what systems are attached to the network at the remote location, what vulnerabilities exist, who uses the systems, what operating systems or software are run on the systems, or what are the characteristics of the systems. The RTD management module 204 may forward this information to other systems for further use. In return, the RTD management module 204 may send further information back to the Enterprise Server 102. For instance, the RTD management module 204 can send vulnerability updates to the RTD 104 for use in improved scanning, security policies to which the RTD 104 must scan for compliance, changes to the asset management policies at the remote location, assignments for resolving discovered vulnerabilities, or information on how to resolve discovered vulnerabilities.

The scanning module 206 scans for many different aspects that effect computer security. These scans can include, but are not limited to, scans for open ports, unauthorized network services, viruses, or Trojan horses. Custom-designed scanning software may be employed by the scanning module 206. However, the scanning module 206 may also employ one or more currently existing scanners including, but not limited to, ISS Internet Scanner, QualysGuard, NEssus, Eeye, Harris, Retina, Microsoft's hfNetCheck, or others. It is immaterial what type of scanner is used in the scanning module 206.

In still another embodiment, scanning tools 209 may operate outside the Enterprise Server 102. For instance, the network security personnel may already employ scanning tool #1 and tool #2 209. An external tool manager module or SDK 208 may provide an interface for these outside scanning tools 209. The SDK 208 can use, for example, an API interface to import XML output from the tools into the Enterprise Server 102. The SDK 208 can manipulate the data to conform to the internal protocols of the scanning module 206 and the remediation module 210.

A remediation manager module 210 helps the organization ameliorate the discovered vulnerabilities. The remediation manager 210 may store the vulnerabilities into the vulnerability database 114. The database 114 may include, but is not limited to, a list of the vulnerabilities, a ranking of the vulnerabilities according to the possible damage it may produce or the likelihood of occurrence, a list of the devices affected and where the devices are located, a description of the vulnerabilities, who was assigned to resolve the vulnerabilities, and methods of resolving the vulnerabilities. The remediation manager 210 allows the vulnerabilities to be assigned to an IT administrator or computer security personnel for resolution of the vulnerability. The remediation database 114 can track when the vulnerability was found, when it was resolved, and whether the resolution was verified. The remediation manager module 210 aids in all the informational requirements for resolution of the vulnerabilities.

The report manager module 212 provides detailed or summary information about the vulnerabilities and the remediation efforts. Some of the information the report manager module 212 may provide includes, but is not limited to, the number of vulnerabilities, the risk rating, where the vulnerabilities are, whether they have been assigned, to whom they have been assigned, whether the vulnerabilities have been fixed, when the fix was done, whether the fix was verified, and who fixed the vulnerability.

The asset manager module 214 can create and store a file that documents the network's attached devices for both the local network and all distant networks. This file may be referred to as the Client Master File (CMF). The CMF may also include, but is not limited to, lists of operating systems, peripherals, software stored or operated on devices, or other information. The CMF may be populated by the scanning module, by importing the information, or by hand entry. The asset manager module 214 may provide information to the scanning module 206 for what needs to be scanned, to the CMF and vulnerability database engine 218 for what needs to be stored, and to the communication engine 216 for what needs to be sent to the collocation facility 404.

A policy manager module 216 allows a system administrator or other personnel to create organization-wide security policies. These securities polices may include, but are not limited to, allowable or disallowable programs, restrictions on certain computers or computer users, allowed systems or peripherals, and other security rules. The policy manager 216 can provide information to the scanning module 206 to narrow or broaden the focus of the tests run. In addition, the policy manager 216 may send the security policy to the RTD management module 204 for distribution to the remote RTDs 104. Thus, a consistent security policy can be adopted and disseminated throughout the organization.

Remote Testing Devices

The RTDs 104 provide the vulnerability scanning function for the distributed networks. An embodiment of the RTD is shown in FIG. 3. An RTD 104 monitors a network block or a range of IP addresses. In addition, the RTDs 104 may report the scanning results to the Enterprise Server 102 or receive updated vulnerability information from the Enterprise Server 102. The Enterprise Server 102 may function as a vulnerability scanner for the network to which it is attached.

In some embodiments, the RTD 104 is a hardware appliance connected to the network it monitors. In an exemplary embodiment, the RTD 104 is a 1U rack mount server running a Pentium Processor that operates a Linux operating system. An RTD 104 may also be software stored in memory on a computer connected to the monitored network. A unique embodiment employs the RTD 104 as a software function recorded on a computer readable media, such as a compact disc (CD). The CD may be a self-bootable program that does not reside in permanent storage but runs from memory, such as RAM or ROM, during its operation. After finishing the monitoring functions, the program is aborted, and the program is erased from the memory. Thus, the remote sites may not need to install any hardware or software but can use the CD to preform all the testing functions.

The RTD 104 includes a scanning module 206 and an enterprise control module 302. In addition, the RTD 104 may include an external tools manager module 208, a remediation manager module 210, a report manager module 212, and an administrative module 202. The scanning module 206, external tools manager module 208, remediation manager module 210, report manager module 212, and the administrative module 202 may function similarly to the similarly named modules in the Enterprise Server 102. The enterprise control module 302 receives the control commands from and sends information to the RTD management module 204. In turn, the enterprise control module 302 communicates with the other various modules to give effect to the Enterprise Server 102 commands.

Collocation Facility

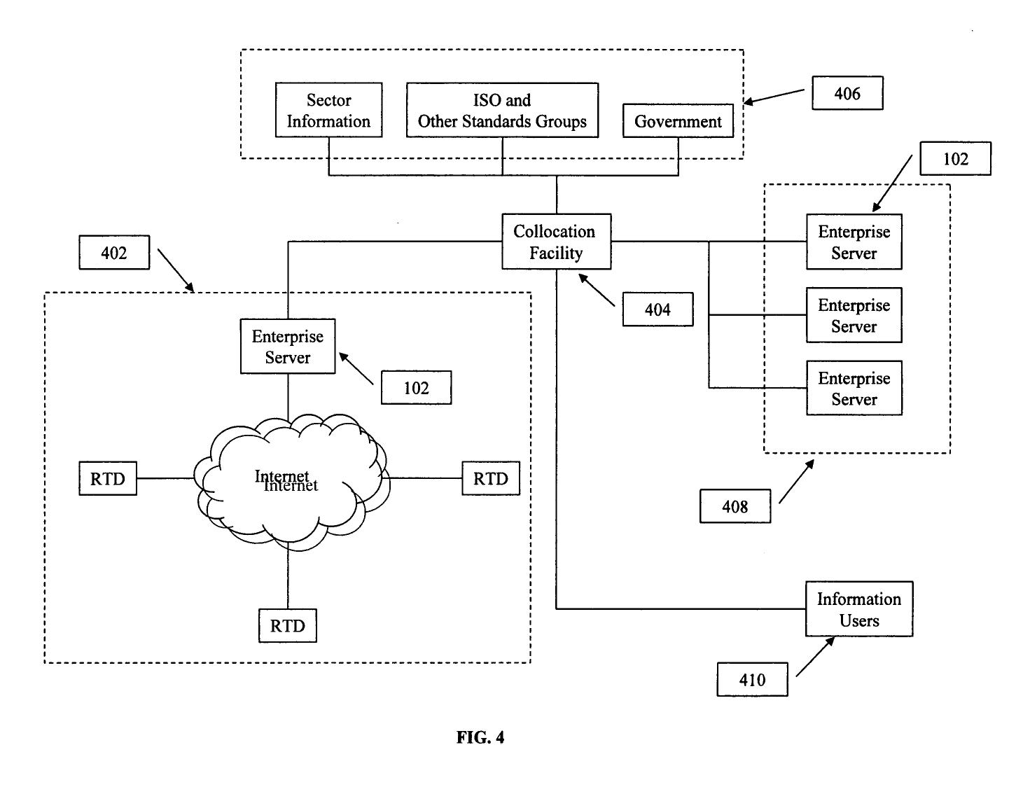

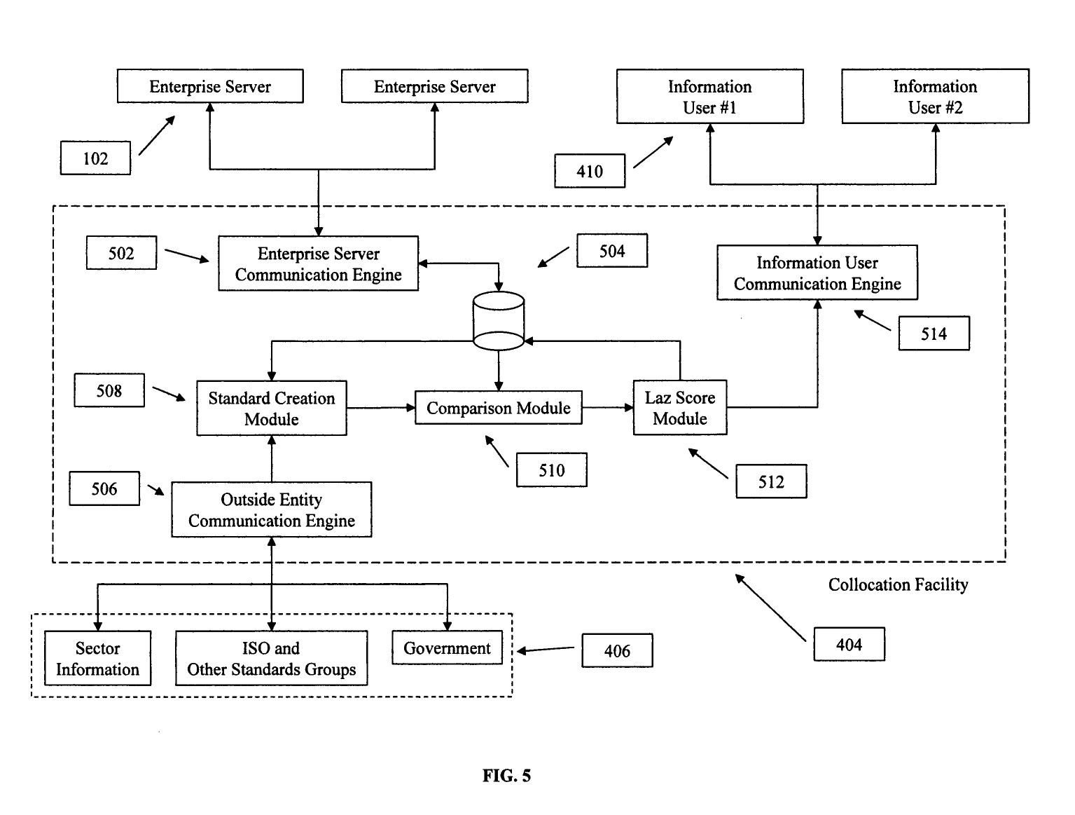

FIG. 4 shows a plurality of computer security management system 100s (represented by the Enterprise servers 102) that may manage the computer security vulnerabilities for a plurality of organizations. FIG. 5 shows one embodiment of the collocation facility 404. In one embodiment, the plurality of Enterprise Servers 102 may be coupled to a collocation facility 404. The collocation facility 404 may have access to each CMF and vulnerability information database 114 stored at each Enterprise Server 102. The CMF can include information about the types of computers used, operating systems, connections, and other information. Particularly, the database 114 may include one or more items of information related to vulnerabilities. This information may include, but is not limited to, the number of open ports, the types of virus protection, the types of software used that connect to public networks, the detected Trojan horses, physical security information, computer access information, and other types of information. The CMF and other information from each Enterprise Server 102 can be stored in a database 504 at the collocation facility 404.

The collocation facility 404 is a computer system. It may include servers, mainframes, or other computing systems. The system 404 is any hardware or software that may accomplish the reception of CMFs and other information, the storage of the CMFs and other information, the establishment of standards, the comparison of the standards to the CMFs and other information, and the generation and reporting of the measurement for computer security. The collocation facility 404 may include an Enterprise Server Communication Engine 502, an Outside Entity Communication Engine 506, an Information User Communication Engine 514, a Standard Creation Module 508, a Comparison Module 510, a Laz Score Module 512, and a database 504.

The Enterprise Server Communication Engine 502, Outside Entity Communication Engine 506, and Information User Communication Engine 514 are all interface modules that communicate with outside systems 102 or organizations 406 and 410. The communication engines 502, 506, and 514 are any hardware or software that can function as an interface with the outside systems 102 and organizations 406 and 410. In an exemplary embodiment, the communication engines 502, 506, and 514 communicate bi-directionally through the internet using HTTPS. Such communication systems 502, 506, and 514 are well known in the art and will not be explained further.

The database 504 is stored in a memory at the collocation facility 404. The memory may be an integrated unit internal to a computer system or some separate memory unit. The memory may include, but is not limited to, any RAM, ROM, tape storage, optical storage, disk drive, or RAID system. The database 504 can store the CMFs from the various networks, other vulnerability information from the various networks, the Laz Scores for the networks, or other information. Databases and memories are well known in the art and will not be explained further.

The standard creation module 508 is the hardware, software, or both hardware and software device that transforms the inputs from the outside entities 406 or the database 504 to form a standard that can be compared to electronically. The exemplary embodiment shown provides for a software module operated by a computer system. The standard creation module 508 configures the inputs into a form comparable to the CMF and other information from the Enterprise Engines 102. This transformation may also include any calculations or other manipulations of the inputs to create the standard.

The comparison module 510 is the software, hardware, or both hardware and software that takes the information from the database 504 and the standard and compares the items of information. In an exemplary embodiment, the comparison module 510 is a software program operated on a computer system. The comparison module 510 interfaces with the standard creation module 508 to obtain the standard and with the database 504 to receive the information to compare to the standard. The comparison may be mathematical, such as a determination of the number of standard deviations from the mean number of vulnerabilities is the current organization's list of vulnerabilities. Comparison may also be logical, such as whether an ISO or other Information Technology security framework or guideline is met or not met. Comparisons may also include relating the current state of vulnerabilities with the organization with the state of the vulnerabilities some time in the past. Also, the comparisons may include peer to peer comparisons, where the state of vulnerabilities may be compared to other companies, groups of companies, or industries. These peer to peer comparisons may be organized in to Standard Industrial Classification (SIC) categories or codes or The North American Industry Classification System (NAICS) categories or codes. Other types of comparisons are contemplated. One skilled in the art will further understand the function of the comparison module 510 by referring to the methods explained below. The comparison produces a set of data that can be sent to the Laz score Module 512.

The Laz score module 512 produces a measurement from the data produced by the comparison module 510. The Laz score module 512 is hardware, software, or both hardware and software. In an exemplary embodiment the Laz score module 512 is a software program operated by a computer system. The Laz score module 512 makes a set of mathematical calculations from the data provided to arrive at either a qualitative measurement, like good or fair computer security, or a quantitative measurement, like 124 points out of a possible 230. One skilled in the art will further understand the function of the Laz score module 512 by referring to the methods explained below. The Laz score module 512 may provide the Laz score to the Information User Communication Engine 514 to send to outside information users 410 or to the database 504 for storage.

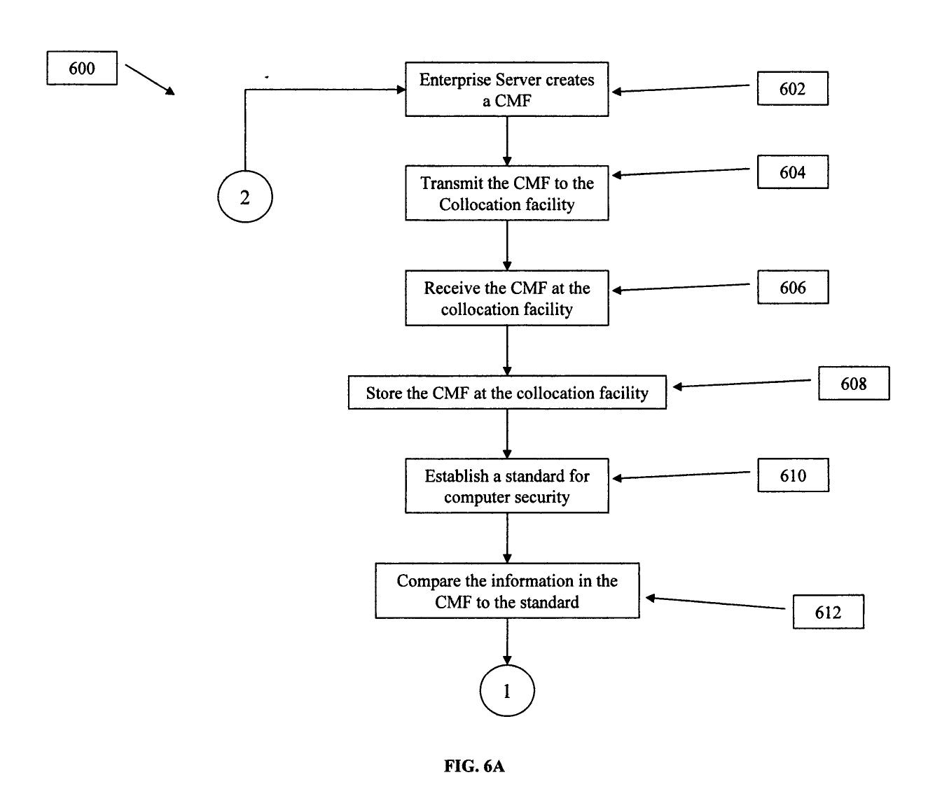

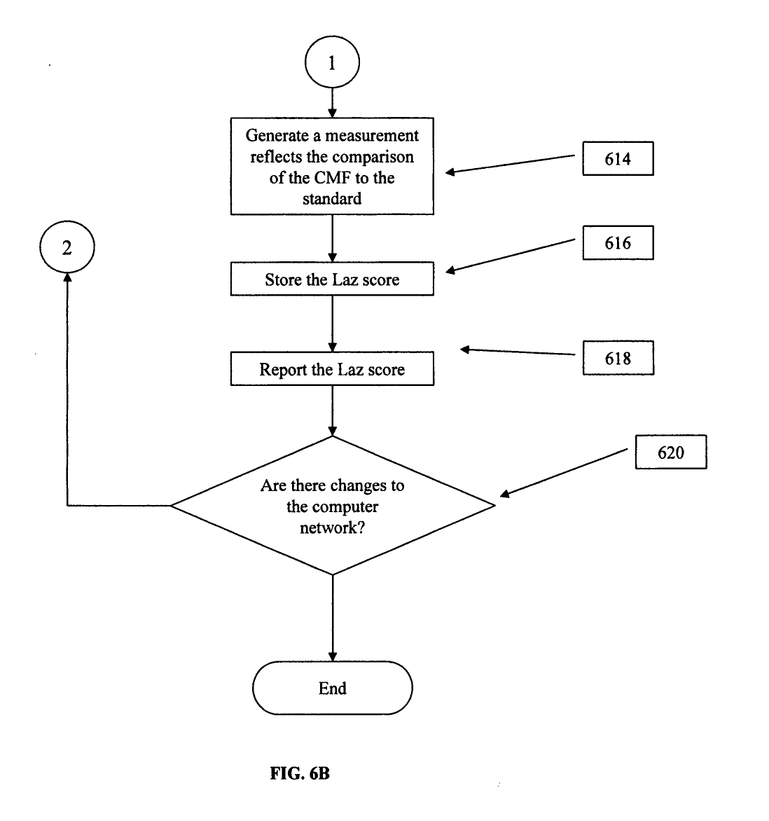

FIG. 6 shows an embodiment of a method 600 to generate a measurement measuring the computer security of an organization. Information about the computer network is generated. In the embodiment shown, the Enterprise Server 102 at each computer network creates 602 the CMF and other information, hereinafter referred to only as the CMF. The CMF includes, but is not limited to information on the structure and layout of the network, on the computer attached to the network, and on vulnerabilities. This information in the CMF is transmitted 604 to the collocation facility 404.

The collocation facility 404 receives 606 and stores 608 the CMF from each Enterprise Server 102 in the database 504. Thus, the collocation facility 404 creates a large database 504 of discovered vulnerabilities from a multitude of networks. After receiving the CMF, the collocation facility 404 establishes 610 a standard. A standard is a benchmark or hallmark that is used to measure the security of every network to a set of objective criteria. Establishing the standard may include, but is not limited to, the procedures that will be explained hereinafter.

The standard may be a set of criteria developed by an outside organization 406. The criteria may include different categories of computer security and a guideline agreed upon by one or more entities. An example of such a standard may be the ISO guidelines or, more specifically, the ISO 17799 guidelines for Computer Security. Other standards may come from the government, self-regulating organizations, or companies with far-reaching industry influence (i.e., payment card companies). For instance, the Homeland Security Department may issue regulations that require organizations to protect their electronic networks and the information those networks store in a certain way or with a certain system. In still other embodiments, a software or other type of vendor may set a security requirement that must be followed by any organization that uses its software or hardware. For instance, virus detection software may require periodic updates of virus detection files. The standard may be established from one or more of the criteria established by these outside entities.

In another embodiment, the standard may be established as an industry baseline. With all of the CMFs from the numerous networks, the collocation facility 404 can create a database 504 with this information. The database 504 can separate the information into different categories. One of those categories may be by industry 408. An industry 408 can be any sector of the economy that the organization occupies. For instance, a church charity may be in a non-profit category, while Microsoft may occupy the software vendor category. An organization may occupy one or more categories. With the information separated into industry category, the collocation facility 404 can calculate statistics describing the networks within those categories. For instance, an average number of vulnerabilities can be determined for each industry category. These industry statistics may form the standard upon which the collocation facility 404 compares the CMF. In another embodiment, the standard may be comprised of statistics from all the networks providing CMF information. These statistics may form a comprehensive or global standard that ignores what industry the organization occupies. Again, the standard may be organized in to Standard Industrial Classification (SIC) categories or codes or The North American Industry Classification System (NAICS) categories or codes. The standards can include multiple files from several or one company. The comparisons may use one or more files from each company or industry. Other methods of establishing standards are contemplated and included in this invention.

Comparing the information to the standard is a process where the relative adherence to the standard is determined. The type of comparison will depend upon the standard used for the comparison and on the information in the CMF that is being compared to that standard. A standard that includes a set of criteria, like the ISO guidelines, will require a certain type of comparison. In this embodiment, the CMF may be compared to obtain information including, but not limited to, how many criteria are met, which criteria are not met, and an measurement of the danger of the unmet criteria. In another embodiment, the CMF can be compared to the industry statistics or comprehensive statistics. Information from this comparison may include, but is not limited to, the number of standard deviations either above or below the average number of vulnerabilities, the types of vulnerabilities in common or different than the statistics, or the severity of the vulnerabilities compared to those found in the statistics. One skilled in the art will recognize other types of comparisons that are included in the invention.

Once the comparison is made, the collocation facility 404 generates 614 a measurement that reflects what was found in the comparison. This measurement may be quantitative or qualitative. Hereinafter, the measurement will be referred to as the Laz score. The Laz score may be a numeric or numeric-based measure. For instance, the Laz score may be a number between 1 and 150, may be a percentage, may be one category out of five possible categories, like bad, fair, good, excellent, or outstanding. One skilled in the art will recognize other possibilities for the Laz score which are included in the present invention. The Laz score also depends on the type of standard, CMF, and comparison made by the collocation facility. A Laz score created by comparing the CMF to ISO guidelines may be a number computed by determining the number of criteria that are not met, multiplying by a number representative of the severity of the missed criteria, and then averaged by the total points possible. This Laz score can provide a score that can be compared across industries and systems. In another embodiment, the Laz score may be a statistical determination of the number of standard deviations either above or below the average number of vulnerabilities for an industry. This Laz score provides a good benchmark for networks in one industry sector. The benchmark may be organized into Standard Industrial Classification (SIC) categories or codes or The North American Industry Classification System (NAICS) categories or codes. One skilled in the art will recognize other Laz scores that are possible for the present invention.

The Laz score may then be stored 616 in the database 504 with the CMF and other information from the organization. The Laz score may be retrieved from the database and reported 618 to information users at anytime. Due to vulnerability remediation efforts, the Laz score can be improved or changed over time. Thus, it must be determined 620 if changes to the computer network may have occurred. These changes may include actions as simple as adding a computer to the network or as complex as merging two organizations' networks together. If a change has occurred, then the process may start over.

While the previous embodiment shows the collocation facility 404 receiving the information to generate the Laz score, it is also envisioned that the Enterprise Server 102 may receive the standard to generate the Laz score. CMFs and other information may still be sent to the collocation facility 404 depending on the type of standard that will be created. In the embodiment, the collocation facility 404 may create the standard. This standard may then be sent to each Enterprise Server 102. The Enterprise Server 102 may then make the comparison between information in the CMF and vulnerability information database 114 and the standard. The results will form the Laz score. Then, the Enterprise Server 102 may report the Laz score to the collocation facility 404. Other information that the Enterprise Server 102 may provide includes, but is not limited to information that is not personally identifiable information, computations, or statistics.

In still another embodiment, the present invention may still include a collocation facility 404 and a plurality of computer security management system 100s. However, the computer security management system 100s may not comprise an Enterprise Server 102. The Enterprise Server 102 presents an automated system, formed from hardware, software, or both hardware and software that can facilitate communications. Yet, the computer security management system 100 need not include an Enterprise Server 102. The CMF or its equivalent and the other vulnerability information may still be sent to the collocation facility 404 from other types of computer security management system 100s. The transmission of the information need not be automated, as the information may be input into the collocation facility 404 once received. All other functions of the measurement system may be similar or the same as one skilled in the art will recognize.

We claim:

1. A system to measure the security risks to computer networks of one or more organizations, comprising:
a. a plurality of computer security management systems, comprising:
i. a computer network;
ii. an Enterprise Server coupled to the computer network;
b. a collocation facility coupled to the plurality of computer security management systems; and
c. wherein the collocation facility receives information from at least one Enterprise Server related to security of the computer network, compares the information from the Enterprise Server against a standard, and generates a Laz score that measures the risk to the security of the computer network.

2. A method to provide a measurement of the security of a computer network, comprising:
a. collecting information at an Enterprise Servers to create a Client Master File and other vulnerability information;
b. sending the client master file and other vulnerability information to a collocation facility;
c. receiving the client master file and other vulnerability information at the collocation facility;
d. comparing one or more items of vulnerability information in the client master file and other vulnerability information against a standard; and
e. generating a Laz score that reflects the comparison of the one or more items of vulnerability information in the client master file and other vulnerability information against a standard.
